(19) United States
(12) Patent Application Publication
(10) Pub. No.: US 2018/0278788 A1
(43) Pub. Date: Sep. 27, 2018

(54) READING APPARATUS

(71) Applicant: FUJI XEROX CO., LTD., Tokyo (JP)

(72) Inventors: Takashi HIRAMATSU, Kanagawa (JP); Kiyofumi AIKAWA, Kanagawa (JP); Masaki HACHISUGA, Kanagawa (JP)

(73) Assignee: FUJI XEROX CO., LTD., Tokyo (JP)

(21) Appl. No.: 15/718,047

(22) Filed: Sep. 28, 2017

(30) Foreign Application Priority Data
Mar. 21, 2017 (JP) 2017-054636

(51) Int. Cl. H04N 1/03; H04N 1/00; H04N 1/193

(52) U.S. Cl. CPC H04N 1/0305; H04N 1/1937; H04N 1/00525

(57) ABSTRACT

A reading apparatus includes an image sensor provided at a terminal end of an optical path, a diaphragm that restricts a quantity of light traveling along the optical path, a concave mirror provided adjacent to and on an upstream side of the diaphragm in the optical path and forms a portion of the optical path, and a convex mirror provided on the upstream side of the concave mirror in the optical path and forms another portion of the optical path.

### CROSS-REFERENCE TO RELATED APPLICATIONS

This application is based on and claims priority under 35 USC 119 from Japanese Patent Application No. 2017-054636 filed Mar. 21, 2017.

### BACKGROUND

### Technical Field

The present invention relates to a reading apparatus.

### SUMMARY

According to an aspect of the invention, there is provided a reading apparatus including an image sensor provided at a terminal end of an optical path, a diaphragm that restricts a quantity of light traveling along the optical path, a concave mirror provided adjacent to and on an upstream side of the diaphragm in the optical path and forms a portion of the optical path, and a convex mirror provided on the upstream side of the concave mirror in the optical path and forms another portion of the optical path.

### BRIEF DESCRIPTION OF THE DRAWINGS

An exemplary embodiment of the present invention will be described in detail based on the following figures, wherein:

FIG. 1 illustrates an overall configuration of an image reading apparatus according to the exemplary embodiment;

FIG. 2 illustrates an appearance of an optical-path-forming unit;

FIG. 3 illustrates the optical-path-forming unit seen in a first scanning direction;

FIG. 4 illustrates a virtual optical-path-forming unit;

FIG. 5 illustrates the optical-path-forming unit seen in a second scanning direction; and

FIG. 6 illustrates an optical-path-forming unit according to a modification.

### DETAILED DESCRIPTION

### (1) Exemplary Embodiment

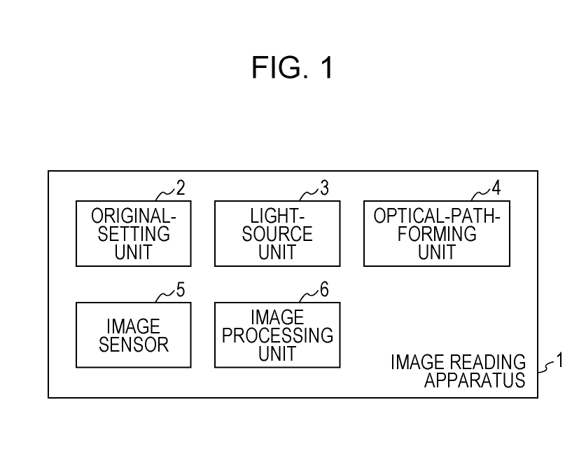

FIG. 1 illustrates an overall configuration of an image reading apparatus 1 according to an exemplary embodiment. The image reading apparatus 1 reads an image on the basis of light reflected by an object of image reading and is an exemplary “reading apparatus” according to the present invention. Exemplary objects of image reading performed by the image reading apparatus 1 include a document having writing, including text and graphics, thereon. The image reading apparatus 1 includes an original-setting unit 2, a light-source unit 3, an optical-path-forming unit 4, an image sensor 5, and an image processing unit 6.

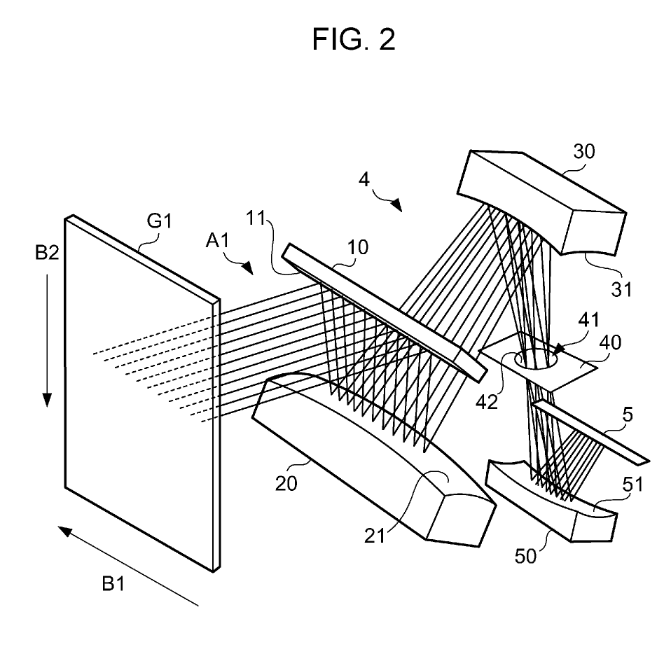

The original-setting unit 2 includes a transparent table on which a document as an original is to be placed, and a covering that presses the original placed on the table, so that the original as an object of image reading is set on the table. The light-source unit 3 includes plural light-emitting diodes (LEDs) or the like aligned in a first scanning direction B1 (see FIG. 2) and applies light to the original that is set on the original-setting unit 2. The light-source unit 3 applies the light over the entirety of the original while moving the light-emitting position in a second scanning direction B2 (see FIG. 2).

The optical-path-forming unit 4 includes plural mirrors and forms a path of the light emitted from the light-source unit 3 and reflected by the original, i.e., an optical path. The optical-path-forming unit 4 forms an optical path extending from the original to the image sensor 5. The image sensor 5 is, for example, a charge-coupled-device (CCD) image sensor and is a line sensor including light-receiving elements aligned in the long-side direction thereof. The image sensor 5 is provided at the terminal end of the optical path formed by the optical-path-forming unit 4, with the long side thereof extending in the first scanning direction B1. The image sensor 5 reads an image on the original on the basis of light (rays) traveling thereto from the original along the optical path.

The light-source unit 3, the optical-path-forming unit 4, and the image sensor 5 of the image reading apparatus 1 are grouped as one unit, and the unit moves in the second scanning direction B2. Hence, the optical path is shorter than in a case where the image sensor is provided at a fixed position. Accordingly, the size of the apparatus is allowed to be reduced. The image processing unit 6 processes the image read by the image sensor 5. For example, the image sensor 5 generates image data and stores the image data in a storage medium such as a hard disk drive (HDD) or transmits the image data to an external apparatus.

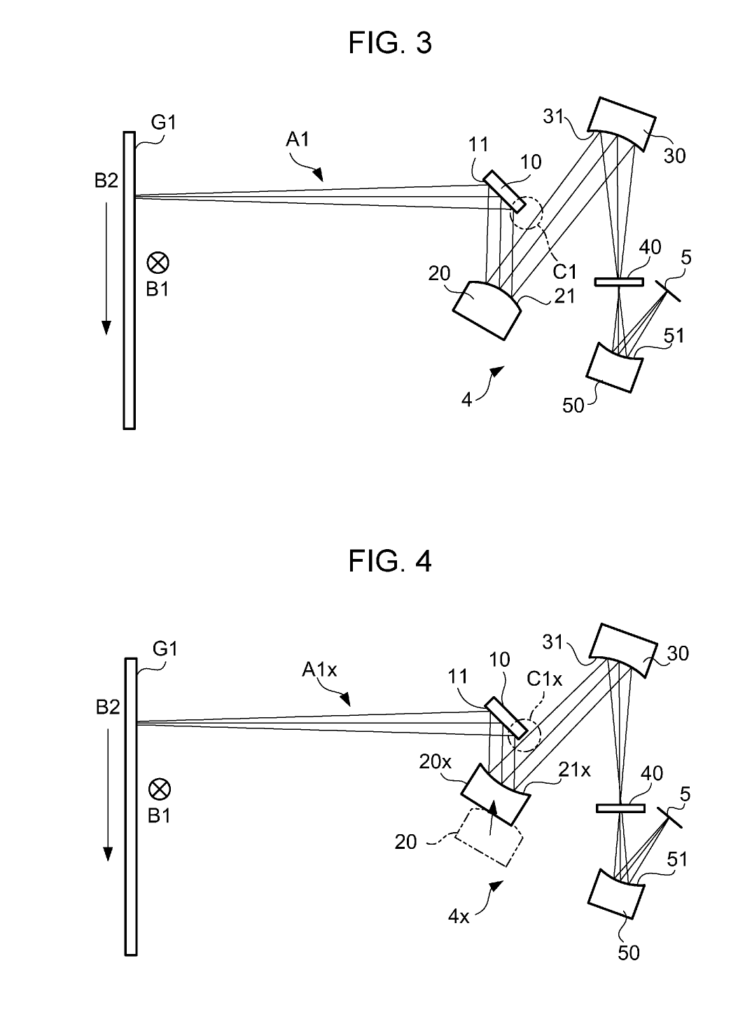

FIG. 2 illustrates an appearance of the optical-path-forming unit 4. FIG. 3 illustrates the optical-path-forming unit 4 seen in the first scanning direction B1. In FIG. 2, an original G1, the image sensor 5, and the optical-path-forming unit 4, which forms an optical path A1 extending from the original G1 to the image sensor 5, are illustrated. The optical path A1 is represented as a group of light rays reflected by the original G1 at respective positions that are aligned in the first scanning direction B1. The optical-path-forming unit 4 includes a mirror 10, a mirror 20, a mirror 30, a diaphragm 40, and a mirror 50. The light from the original G1 is reflected by the mirrors 10, 20, and 30 in that order, travels through the diaphragm 40, is reflected by the mirror 50, and reaches the image sensor 5. As illustrated in FIG. 2, the optical-path-forming unit 4 is a reflection optical system whose optical axis includes portions extending in different directions.

Specifically, the mirror 10 is provided on the upstream side of the mirror 20 in the optical path A1 and adjacent to the mirror 20 in the optical path A1. Hereinafter, the terms “the upstream side” and “the downstream side” refer to the upstream side and the downstream side, respectively, in the optical path A1. In addition, the state where mirrors are adjacent to each other refers to a state where no mirrors are provided between such mirrors in the optical path A1. In other words, the two mirrors are arranged such that the light reflected by the upstream one of the two is directly incident on the downstream one. This also applies to the relationship between any mirror and the diaphragm 40 adjacent thereto.

The mirror 20 is provided on the downstream side of the mirror 10 and on the upstream side of the mirror 30 and is adjacent to the mirror 30. The mirror 30 is provided on the downstream side of the mirror 20 and on the upstream side of the diaphragm 40 and is adjacent to the diaphragm 40. The diaphragm 40 is provided on the downstream side of the mirror 30 and on the upstream side of the mirror 50 and is adjacent to the mirror 50. The mirror 50 is provided on the downstream side of the diaphragm 40 and on the upstream side of the image sensor 5 and is adjacent to the image sensor 5.

The mirror 10 is a flat mirror having a flat mirror surface 11. The mirror 20 has a mirror surface 21. The mirror 30 has a mirror surface 31. The mirror 50 has a mirror surface 51. The mirror surfaces 21, 31, and 51 are each a free-form surface. The term “free-form surface” refers to a curved surface having a complicated shape that is different from a spherical shape, the peripheral surface of a cylinder, or the like. For example, the shape of the free-form surface is expressed by the following x-y polynomial: z=C₀₂×y²+C₂₀×x²+C₀₃×y³+C₂₁×x²×y²+C₀₄×y⁴+C₂₂×x²×y²+C₄₀×x⁴+C₀₅×⁵+C₂₃×x²×y³+C₄₁×x⁴×y+C₀₆×y_{6+C}₂₄×x²×y⁴+C₄₂×x⁴×y²+C₆₀×x⁶. This x-y polynomial expresses a curved surface in an X-Y-Z coordinate system in which the long-side direction of the mirror surface corresponds to the X axis, the short-side direction of the mirror surface corresponds to the Y axis, and the direction of the normal passing through the center of the mirror surface corresponds to the Z axis.

The mirror 20 is a convex mirror with the mirror surface 21 curving outward. The mirrors 30 and 50 are concave mirrors with the mirror surfaces 31 and 51 curving inward. Specifically, the mirror 30 is a concave mirror provided adjacent to and on the upstream side of the diaphragm 40 in the optical path A1, thereby forming a portion of the optical path A1. Furthermore, the mirror 20 is a convex mirror provided adjacent to and on the upstream side of the mirror 20 in the optical path A1, thereby forming another portion of the optical path A1. In the present exemplary embodiment, the mirror 20 is provided at the most upstream position in the optical path A1 among the plural curved mirrors (the mirrors 20, 30, and 50) that form the optical path A1. The mirror 20 is an exemplary “convex mirror” according to the present invention. The mirror 30 is an exemplary “concave mirror” according to the present invention.

Regarding a mirror having a curved mirror surface, the degree of the curve of the surface is occasionally referred to as the power. If the power is 0, the surface is flat with no curve. If the power is positive, the surface forms a concave surface that converges light rays. If the power is negative, the surface forms a convex surface that diverges light rays. That is, the mirror surface 11 of the mirror 10 has a power of 0 (a flat surface), the mirror surface 21 of the mirror 20 has a negative power (a convex surface), and the mirror surfaces 31 and 51 of the mirrors 30 and 50 each have a positive power (a concave surface).

The power of the free-form surface is determined by the coefficients of the quadratics in the above polynomial. For example, in the case of the above x-y polynomial, the power in the long-side direction of the mirror is expressed as p=4×C₂₀, and the power in the short-side direction of the mirror is expressed as p=4×C₀₂. The mirror has a focal length f expressed as the reciprocal of the power (f=1/p). For example, the mirror 20, which is a convex mirror, has a negative power. Therefore, the focal length f of the mirror 20 is longer than that of a concave mirror, which has a positive power.

If the mirror 20 is replaced with a concave mirror having a positive power, the following problem arises.

FIG. 4 illustrates a virtual optical-path-forming unit 4x. The optical-path-forming unit 4x includes a concave mirror 20x in replacement of the mirror 20 illustrated in FIG. 3. That is, the curved mirrors included in the optical-path-forming unit 4x are all concave mirrors. The mirror 20x has a mirror surface 21x having a positive power. In FIG. 4, the position of the mirror 20 is represented by two-dot chain lines.

Among the light rays reflected by the original G1, some rays that are incident on the mirror 10 travel while diverging. Then, such rays are reflected by the concave mirrors while converging gradually, and totally converge (meet at one point) upon the diaphragm 40. The rays thus converged diverge again while further traveling along an optical path A1x and are reflected by the mirror 50, thereby converging again upon the image sensor 5. In the optical-path-forming unit 4, rays reflected by the mirror 20, which is a convex mirror, and by the mirror 30, which is a concave mirror, converge upon the diaphragm 40.

On the other hand, in the optical-path-forming unit 4x including the concave mirror 20x in replacement of the mirror 20, if the mirror 20x is provided at the same position as the mirror 20, rays totally converge before reaching the diaphragm 40. To converge rays upon the diaphragm 40, the optical path A1x between the mirror 10 and the diaphragm 40 needs to be made shorter. That is, as illustrated in FIG. 4, the mirror 20x needs to be brought closer to the mirror 10 and to the mirror 30. Consequently, the optical path A1x passes a position closer to the mirror 10 than the optical path A1 (compare an area C1 in FIG. 3 and an area C1x in FIG. 4).

The original G1 reflects light in all directions. Therefore, some rays reflected at positions that are out of the reading area may be incident on the mirror 10. Such rays may deviate from the optical path formed by the mirrors (the optical path along which rays that are expected to reach the image sensor 5). In such an event, some rays may strike the mirror 10 in the area C1x, be reflected in unexpected directions, and reach the image sensor 5, causing disturbance.

In the optical-path-forming unit 4, the optical path A1 passes a position farther from the mirror 10 in the area C1 than the optical path A1x in the area C1x. Hence, even if there are any rays deviating from the optical path A1, such rays are less likely to strike the mirror 10 and are therefore less likely to cause disturbance than in the optical-path-forming unit 4x in which the optical path A1x is formed only by the concave mirrors.

The diaphragm 40 is a member that restricts the quantity of light traveling along the optical path A1. The diaphragm 40 is a rectangular plate-like member having a circular hole 41 in the center thereof. Depending on the material (fabric, for example) forming the original G1, the light reflected by the original G1 may contain infrared rays. If such infrared rays are incident on the image sensor 5, the color of the read image is more likely to be expressed differently from the actual color than in a case where only visible light rays are incident on the image sensor 5.

To avoid such a situation, the image reading apparatus 1 includes an infrared-ray filter 42 (infrared cut filter, abbreviated to IRCF) provided in the hole 41 of the diaphragm 40. The optical path A1 is narrowest at the diaphragm 40, ignoring the positon immediately before the image sensor 5. Hence, the size of the infrared-ray filter 42 is smaller than in a case where an infrared-ray filter is provided at any other position. Moreover, the diaphragm 40 is supported in such a manner as to be positioned in the optical path A1. Hence, there is no need to provide any dedicated member for supporting the infrared-ray filter 42.

If an infrared-ray filter is provided immediately before the image sensor 5, any member that supports the infrared-ray filter needs to be provided separately, increasing the cost and the weight of the unit. In the present exemplary embodiment where the infrared-ray filter 42 is provided in the diaphragm 40, the size of the infrared-ray filter is smaller than in a case where the infrared-ray filter is provided at any other position. Consequently, the size of the image reading apparatus 1 may be reduced, and the weight of the image reading apparatus 1 may also be reduced by the weight of the additional supporting member.

The infrared-ray filter 42 includes a glass plate and a dielectric multilayer film deposited on the glass plate. Hence, the transmission spectrum varies with the angle of incidence of light upon the infrared-ray filter 42.

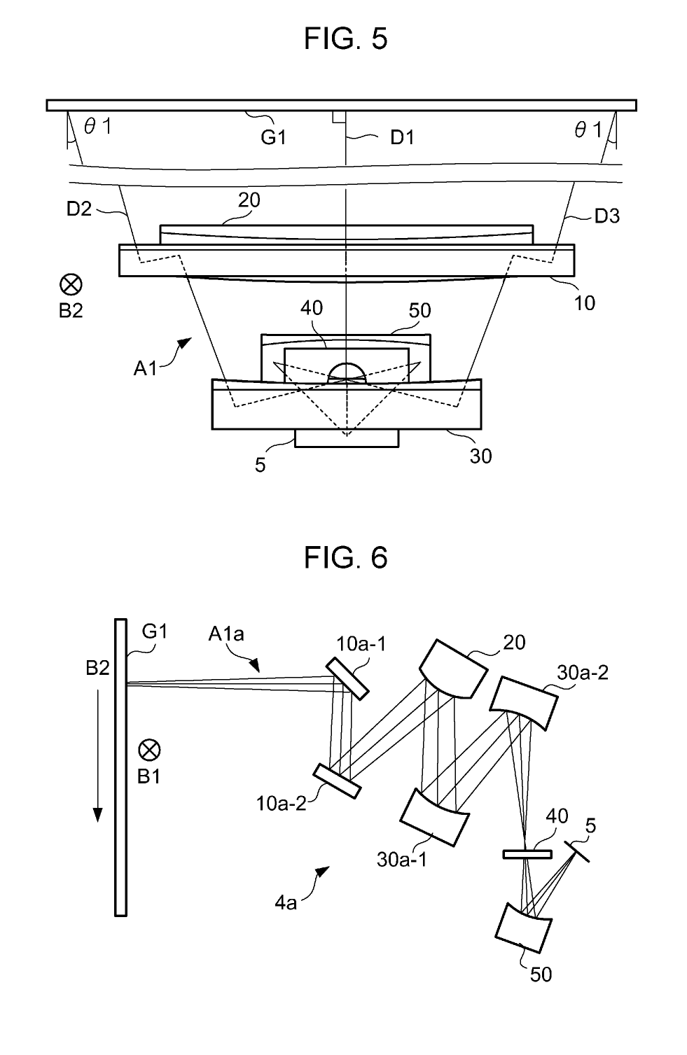

FIG. 5 illustrates the optical-path-forming unit 4 seen in the second scanning direction B2. The light reflected by the original G1 travels along the optical path A1 while gradually converging and reaches the image sensor 5. In the center of the original G1, a ray D1 reflected in the direction of the normal to the original G1 travels along the optical path A1 and is therefore incident on the infrared-ray filter 42 with no inclination (i.e., at an angle of incidence of 0 degrees).

On the other hand, at each end of the original G1, a ray D2 or D3 of the light traveling along the optical path A1 is reflected in a direction inclined with respect to the direction of the normal to the original G1 (in the case illustrated in FIG. 5, inclined at an angle θ1). Hence, the rays D2 and D3 are each incident on the infrared-ray filter 42 with a certain inclination (at an angle of incidence greater than 0 degrees). If the angle of incidence differs between that at the center of the original G1 and that at the end of the original G1, the transmission spectrum also differs between the two positions. Consequently, the color of the read image tends to appear differently between different positions (the appearance of the color may vary with the position of the image). Hence, the difference in the angle of incidence on the infrared-ray filter 42 between rays reflected at different positions of the original G1 is desired to be as small as possible. As described above, if the angle of incidence of the ray reflected at the center of the original G1 is 0 degrees, the angle of incidence of the ray reflected at the end of the original G1 is desired to be as small as possible.

### (2) Modification

The above embodiment is only an example of the present invention and may be modified as follows. Moreover, the above exemplary embodiment and any of the following modifications may be combined together according to need.

### (2-1) Number of Mirrors

The number of mirrors included in the optical-path-forming unit 4 and the arrangement of the mirrors may be different from those employed in the above exemplary embodiment. While the optical-path-forming unit 4 according to the above exemplary embodiment includes three curved mirrors, the optical-path-forming unit may include four or more curved mirrors. Moreover, while the optical-path-forming unit 4 according to the above exemplary embodiment includes one flat mirror, the optical-path-forming unit may include two or more flat mirrors, or no flat mirrors.

While the above exemplary embodiment concerns a case where only one concave mirror (the mirror 50) is provided on the downstream side of the diaphragm 40 and on the upstream side of the image sensor 5, plural concave mirrors or a flat mirror and a convex mirror may be provided between the diaphragm 40 and the image sensor 5. While the above exemplary embodiment concerns a case where one concave mirror (the mirror 30), one convex mirror (the mirror 20), and one flat mirror (mirror 10) are provided on the upstream side of the diaphragm 40, two or more concave mirrors and two or more flat mirrors may be provided, as long as a convex mirror is provided on the upstream side of a concave mirror provided adjacent to and on the upstream side of the diaphragm 40.

FIG. 6 illustrates an optical-path-forming unit 4a according to a modification. The optical-path-forming unit 4a includes mirrors 10a-1 and 10a-2 (also denoted as “mirrors 10a” unless the two need to be distinguished from each other), the mirror 20, mirrors 30a-1 and 30a-2 (also denoted as “mirrors 30a” unless the two need to be distinguished from each other), the diaphragm 40, and the mirror 50. The mirrors 10a are flat mirrors provided on the upstream side of the mirror 20, thereby forming a portion of an optical path A1a. The mirrors 30a are concave mirrors provided on the downstream side of the mirror 20 and on the upstream side of the diaphragm 40, thereby forming another portion of the optical path A1a.

As described above, among the plural curved mirrors included in the optical-path-forming unit 4a, the mirror 20, which is a convex mirror, is provided at the most upstream position. Rays tend to deviate from the optical path on the upstream side of the optical path (because rays that have deviated from the upstream portion of the optical path do not reach the downstream portion of the optical path). Hence, if the mirror 20 is provided at the most upstream position among the curved mirrors and the optical path is made longer both on the upstream side and on the downstream side thereof than in a case where a concave mirror is provided at the most upstream position among the curved mirrors, rays that tend to deviate from the optical path become less likely to strike any reflecting members provided in the optical path.

The most upstream one of the plural curved mirrors included in the optical-path-forming unit 4 does not necessarily need to be a convex mirror. For example, the mirrors may be arranged in the following order from the upstream side: a flat mirror, a concave mirror, a convex mirror, a concave mirror, and the diaphragm 40. In such a case also, the optical path may be made longer both on the upstream side and on the downstream side of the convex mirror than in the case where the optical-path-forming unit includes only concave mirrors. Hence, rays that tend to deviate from the optical path become less likely to strike any reflecting members provided in the optical path.

### (2-2) Mirror Surface of Curved Mirror

While the above exemplary embodiment concerns a case where the curved mirrors (concave and convex mirrors) included in the optical-path-forming unit 4 each have a free-form mirror surface that is expressed by the above x-y polynomial, the present invention is not limited to such a case. The curved mirrors may each have a free-form surface expressed by another x-y polynomial, or may each have a spherical surface.

### (2-3) Object of Image Reading

While the above exemplary embodiment concerns a case where the object of image reading is a document having writing, including text and graphics, thereon and the image reading apparatus 1 is a so-called scanner that reads the document by using a line sensor, the present invention is not limited to such a case. For example, the object of image reading may be an object to be photographed. In that case, the image reading apparatus is a so-called digital camera, and the image sensor corresponds to an area sensor including light-receiving elements arranged two dimensionally.

A digital camera is suitable for shooting a three-dimensional object. In contrast, in a case where a line sensor is employed as with the image reading apparatus 1 according to the above exemplary embodiment, a two-dimensional object (such as a document) is easier to read than in the case where the image reading apparatus includes an area sensor. In either case of image reading, providing the above convex and concave mirrors as reflecting members makes rays that deviate from the optical path be less likely to strike the reflecting members as described in the above exemplary embodiment, reducing the probability of the occurrence of disturbance caused by such rays.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A reading apparatus comprising:
an image sensor provided at a terminal end of an optical path;
a diaphragm that restricts a quantity of light traveling along the optical path;
a concave mirror provided adjacent to and on an upstream side of the diaphragm in the optical path and forms a portion of the optical path; and
a convex mirror provided on the upstream side of the concave mirror in the optical path and forms another portion of the optical path.

2. The reading apparatus according to claim 1, wherein the convex mirror is one of a plurality of curved mirrors that form the optical path, and the convex mirror is provided at a most upstream position in the optical path among the plurality of curved mirrors.

3. The reading apparatus according to claim 1, wherein the diaphragm is provided with an infrared-ray filter.

4. The reading apparatus according to claim 2, wherein the diaphragm is provided with an infrared-ray filter.

5. The reading apparatus according to claim 1, wherein the image sensor is a line sensor provided such that a long side of the line sensor extends in a scanning direction.

6. The reading apparatus according to claim 2, wherein the image sensor is a line sensor provided such that a long side of the line sensor extends in a scanning direction.

7. The reading apparatus according to claim 3, wherein the image sensor is a line sensor provided such that a long side of the line sensor extends in a scanning direction.
